(19) United States
(12) Patent Application Publication
(10) Pub. No.: US 2002/0170663 A1
(43) Pub. Date: Nov. 21, 2002

(54) Automatic tape applicator and method of applying tape to a panel

(76) Inventor: George D. Dailey JR., Doylestown, PA (US)

Correspondence Address: VOLPE AND KOENIG, P.C., SUITE 400, ONE PENN CENTER, 1617 JOHN F. KENNEDY BOULEVARD, PHILADELPHIA, PA, 19103, US

(21) Appl. No.: 09/858,845

(22) Filed: May 16, 2001

(51) Int. Cl. B32B 31/00

(52) U.S. Cl. 156/257; 156/353

(57) ABSTRACT

An automated apparatus and method for applying tape to a panel such as a rectangular pane of glass. Tape is dispensed from a tape applicator and applied to a panel proximate the perimeter of the panel by moving the tape applicator along a path corresponding generally to the perimeter of the panel. Successive tape corners are formed by cutting a notch into a portion of the tape which is applied to form the tape corners. The notch is formed so that when a tape corner is formed on the panel the notch reduces an amount of bunched tape material located at the tape corner thereby producing a relatively flat corner. The final tape corner is formed by substantially severing the tape at a select location and continuing to move the tape applicator while preventing feeding of the tape to cause separation of the tape so that the separated tape end abuts the initially applied tape portion of the tape on the panel.

The present invention is directed to tape applicators and, more specifically, to an automatic device and method for dispensing tape in a pattern on a surface of a panel such as a window pane.

### BACKGROUND

Double pane glass windows are well known particularly for their qualities of providing an insulated window. In one example, two panels of glass are adhered together with a sealed air space defined between the two panels. One method of creating such a double pane glass structure is to apply a double-sided tape on the surface of one pane entirely around its perimeter. The tape usually is supplied with a non-stick protective layer on one side which is removed prior to placing the second pane on top of the double-sided tape to form a sealed air space between the two panes.

Additionally, double sided tape can also be used to mount double or single panes of glass in a frame. Typically, the tape is manually applied to either the frame or to the glass pane, then the two components are stuck together. When done with care, the tape provides an essentially airtight seal between the window pane and the frame.

In manufacturing double pane glass or mounting glass panels using double sided tape, the tape is conventionally manually applied. Hand-held tape dispensers are known which cut notches in a tape so that a relatively flat corner may be formed. However, use of a hand-held tape dispenser is very labor intensive and time consuming.

Applicants have recognized that it would be desirable to provide a tape applicator and a method of applying tape to a panel that allows automation of the tape application process.

### SUMMARY

The present invention is directed to an apparatus and a method for applying adhesive tape to a surface of a panel, typically a glass panel or pane. The panel has a perimeter defined by a plurality of edges that form successive panel corners. A panel support is provided for aligning one corner of the panel with a predetermined reference point. A tape applicator is provided which is mounted for selected movement over a panel positioned on the panel support in response to an associated sensor. A panel is positioned on the panel support such that a first panel corner is located at the predetermined reference point. Tape is dispensed from the tape applicator and applied to the surface of the panel starting proximate to a first corner at the predetermined reference point and along a path corresponding to the perimeter of the panel so that a plurality of tape corners are formed on the panel surface that corresponds to the panel corners.

The position of the tape applicator is sensed relative to successive panel edges along the path to determine the approach of the tape applicator to successive panel corners. Due to panel symmetry, for rectangular panels, as the tape applicator travels away from the first corner, sensing is required for only the next two successive corners. Thereafter, the controller is able to calculate the approach of the tape applicator to the fourth corner and the return of the first corner.

In response to approaching each successive panel corner, except the return to the first corner, a notch is cut in the tape and the tape applicator is turned on its tape applying path so that a tape corner is formed from the notched portion of tape thereby providing a relatively flat corner. In response to the sensing the return to the first panel corner, in lieu of being notched, the tape is partially cut at a location corresponding to the placement of the initially applied tape at the first panel corner. After the cut is made, the tape applicator continues along its path to pass over the initially applied end portion of the tape and a tape brake is applied, preventing the feeding of additional tape from the tape applicator. This causes the tape to separate from the tape applicator along the partially cut section resulting in a separated tape end which abuts the initially applied tape end to form a flat tape corner corresponding to the first panel corner.

The tape applicator head preferably includes a tape feed path and a number of associated components. A tape dispensing brake is disposed proximate the tape feed path. The tape dispensing brake is configured to move between a first position, in which the tape dispensing brake contacts tape in the feed path and prevents movement of the tape along the tape feed path, and a second position in which the tape dispensing brake is remote from the tape feed path. A first cutting member is disposed proximate the tape feed path which has a cutting edge. The cutting edge is movable into contact with tape at a predetermined location in the tape feed path to slice through a portion of the tape. A second cutting member is disposed proximate the tape feed path which has a tape punch. The tape punch is contactible with tape at a predetermined location in the tape feed path to cut a notch along a longitudinal edge of the tape such that a relatively flat tape corner can be formed on a panel surface of the panel. The notch reduces the amount of bunched tape in formation of a tape corner.

Other objects and advantages of the present invention will be apparent to those of ordinary skill in the art from the following detailed description of the invention.

### BRIEF DESCRIPTION OF THE DRAWINGS

FIG. 1 is a schematic diagram of a tape applicator apparatus according to the preferred embodiment of the present invention;

FIG. 2 is a top plan view of a panel disposed on the support of FIG. 1 illustrating tape positioned along a major panel surface;

FIG. 3 is a top plan view of a piece of tape having a notch therein;

FIG. 4 is a top plan view of the portion of the panel identified by the numeral “4” in FIG. 2;

FIG. 5 illustrates a partially severed piece of tape;

FIG. 6 is a longitudinal cross-sectional view of the tape of FIG. 2; and

FIG. 7 is a schematic view of the tape applicator of FIG. 1.

### DETAILED DESCRIPTION OF THE PREFERRED EMBODIMENT

Certain terminology is used in the following description for convenience only and is not limiting. The words “right”, “left”, “lower” and “upper” designate directions in the drawings to which reference is made. The words “inwardly” and “outwardly” refer to directions toward and away from, respectively, the geometric center of the tape applicator and designated parts thereof.

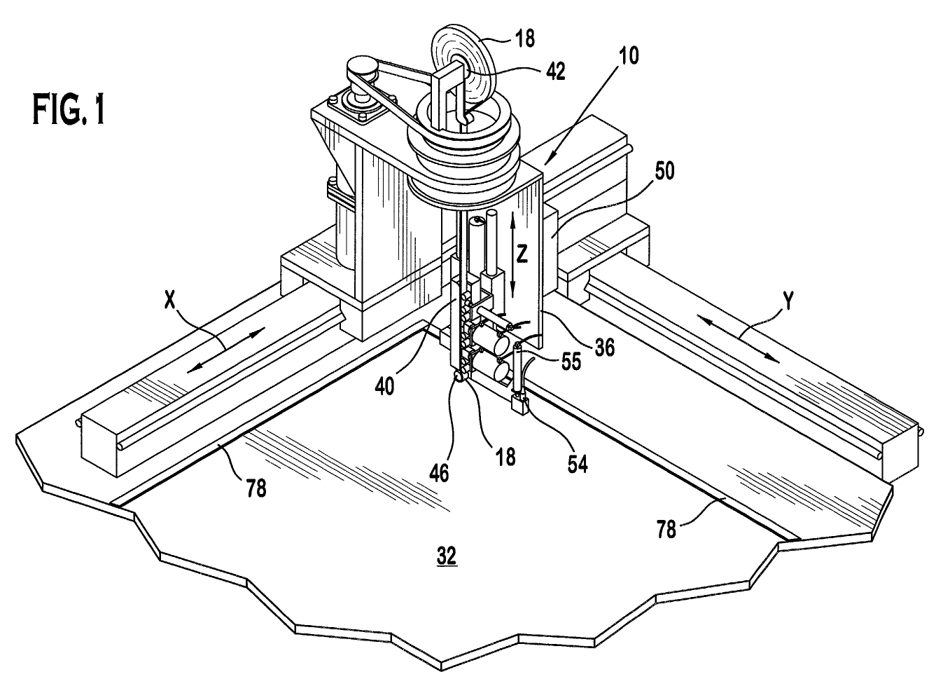

Referring to FIGS. 1, 2 and 7, the tape applicator apparatus of the present invention is configured to apply tape 18 to a glass pane or other type of panel 14 in a predetermined pattern. The tape applicator or head 10 is mounted in a convention manner with respect to a panel support 32 for three dimensional movement, i.e., in any combination of the “X,” “Y,” and “Z” directions, as well as rotating about the “Z” axis.

Computer controlled servo motors are preferred to control the tape head movement with precision in “X”, “Y” and “Z” linear directions. The application of double-sided tape 18 to the surface, proximate the edges 20, of a glass pane, for example, allows the glass pane to be secured to a second pane of glass (not shown) or to be mounted within a frame (not shown) in a sealed relationship. The automated application of tape 18 increases the efficiency of window manufacturing and lowers manufacturing costs. While particularly useful in window manufacturing, the present invention includes the application of tape 18 to panels 14 formed of any material regardless of the anticipated use of the panels 14, and particularly where the tape is applied in a closed loop path.

The tape applicator 10 and its components are preferably formed of a durable, strong material, such as heavy duty polymer, steel or the like. The tape applicator 10 is preferably driven by computer controlled servo motors, but can be driven through its motion above the panel support 32 using any conventional means known to those of ordinary skill in the art. MCG brand servo motors are preferred in association with a computer controller available from Galil Motion Control, Inc. One example of an apparatus for moving an operational head over a predetermined area is disclosed in U.S. Pat. No. 4,766,661 which is hereby incorporated by reference herein in its entirety.

The tape applicator 10 is rotatable about the “Z” axis which is generally perpendicular to the panel support 32 to allow the direction of the tape application to be changed in the plane define by the “X” and “Y” axes. It is preferred that the tape applicator 10 be rotatably secured using a bearing mount to allow rotation. The rotation of the tape applicator body 36 can be driven by an electrical motor or by any other means known to those of ordinary skill in the art.

For applying the tape to rectangular or square panels, the tape applicator is preferably rotatably mounted for making three (3) clockwise 90° turns, on its Z axis during the tape application process, and a return rotation of 270° in a counter-clockwise direction to a ready position for the next application of tape. If hexagonal or other shaped panels are to have tape applied, the rotational displacement of other tape applicator 10 is configured accordingly, i.e. for hexagonal panels the tape head 10 is mounted for rotatable “Z” movement in five 60° increments and a return counter rotation of 300°.

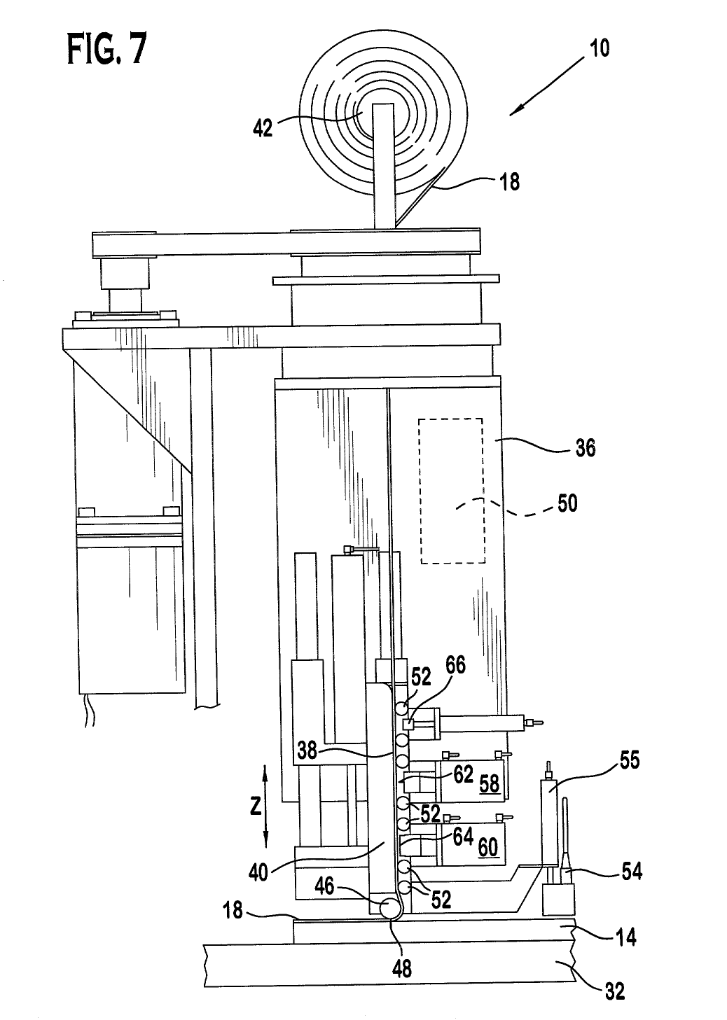

As best seen in FIG. 7, the tape applicator 10 has a body 36 in which is defined a tape feed path 38 extending along a tape guide 40. The tape guide 40 extends generally perpendicular to the panel 14 to guide the tape 18 that is moving through the tape applicator 10 toward the surface 12 of a panel 14.

A tape holder 42 is disposed on the applicator body 36 for feeding tape 18 to an inlet end of the tape feed path 38 with a sticky tape side facing away from the guide 40 and a covered side facing toward the tape guide 40. A pressing member 46 is disposed on the applicator body 36 proximate an outlet end of the tape feed path 38 to apply pressure to the tape 18 for assisting in its adhesion to a panel 14. The preferred embodiment of the pressing member is a roller. The tape 18 is dispensed from the tape holder 42 through the tape feed path by force created on the tape 18 by movement of the tape applicator 10 while a portion 48 of the tape 18 is adhered to the panel 14.

A controller 50 controls the positioning, movement and operation of the tape applicator 10. A sensor 54, which provides signals to the controller, is provided to detect the position of the tape applicator 10 as it approaches successive corners. The sensor is preferably disposed directly in front of the outlet of the tape path at a predetermined distance from the pressing member 46 to sense an edge 20 of a panel 14 as it is approached by the tape applicator.

In a preferred embodiment, when the apparatus is configured for applying tape to a rectangular panel, it is only necessary to employ the sensor to detect the first two successive corners which are approached by the tape applicator head 10 during operation. After two corners are detected the controller has sufficient information to determining the length of the first two successive sides of the rectangular panel. Since the third and forth successive sides of a rectangle are equal in length to the first an second sides, respectively, the controller requires no further sensing data to complete the tape applicator for the third and forth sides. Accordingly, the sensor 54 is preferably mounted to the application head 10 via a vertically oriented cylinder 55 so that the sensor can be raised away from the panel after sensing the second panel edge.

Where the apparatus is configured to apply tape to panels having all sides of equal length, such as square, regular hexagonal or regular octagonal, the sensor 54 is only required to detect the first corner approached by the applicator head 10. In such instances the number of sides, corner angles and side lengths are all known to the controller based upon the predetermined panel shape and the length of one side as determined using the sensor 54.

A brake 56, a first cutting member 58, and a second cutting member 60 are provided along the tape feed path 38 to selectively engage the tape 18 in response to instructions from the controller 50. The brake 56, the first cutting member 58, and the second cutting member 60 are preferably driven using a conventional hydraulic system to drive the operative parts in a reciprocating manner. However, any other conventional braking and/or cutting devices may be used.

The tape dispensing brake 56 is disposed on the applicator body 36 proximate the tape feed path 38. The brake 56 is configured to move between a first position, in which the tape dispensing brake 56 contacts the tape 18 and prevents movement of the tape 18 along the tape feed path 38 and a second position, in which the tape dispensing brake 56 is disengaged from the tape. In the first position, the tape 18 is held between the brake 56 and the tape guide 40. The portion of the brake 56 which contacts the tape is preferably a stick resistance material, so that the tape does not stick to the brake when it moves from its first braking position to its second release position.

The first cutting member 58 is disposed on the applicator body 36 proximate to the tape feed path 38. The first cutting member 58 has a cutting edge 62 that is movable into contact with the tape 18 to slice partially through the portion of the tape. Referring to FIG. 5, it is preferred that the cutting edge 62 slice through approximately seven-eighths of the width of the tape making a cut perpendicular to the edge of the tape so that the tape can be broken to form two separated ends which are substantially straight.

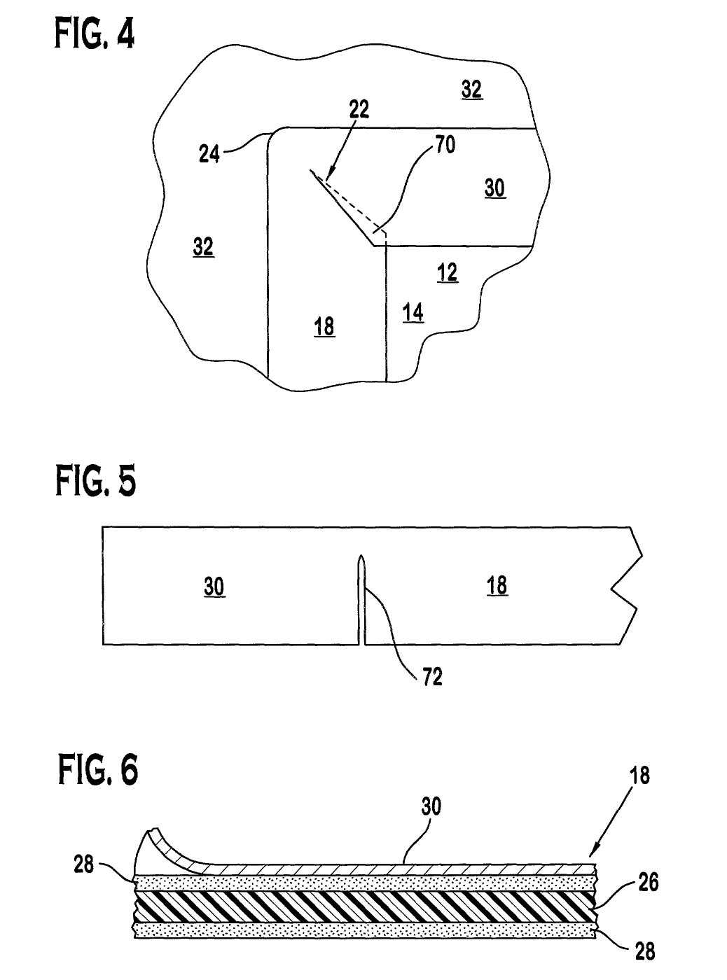

Referring to FIG. 7, the second cutting member 60 is disposed on the applicator body 36 proximate to the tape feed path 38. The second cutting member 38 has a tape punch 64. The tape punch 64 is contactible with the tape 18, preferably as illustrated in FIG. 3, to cut a notch 66 along a longitudinal edge 68 of the tape 18 such that a relatively flat tape corner 22 (shown in FIG. 4) can be formed on the major surface 12 of the panel 14 without excessive bunched tape 70 at the tape corner 24. Relatively flat tape corners facilitate the formation of a seal between the panel and another component to which it is adhered after the tape 18 has been applied.

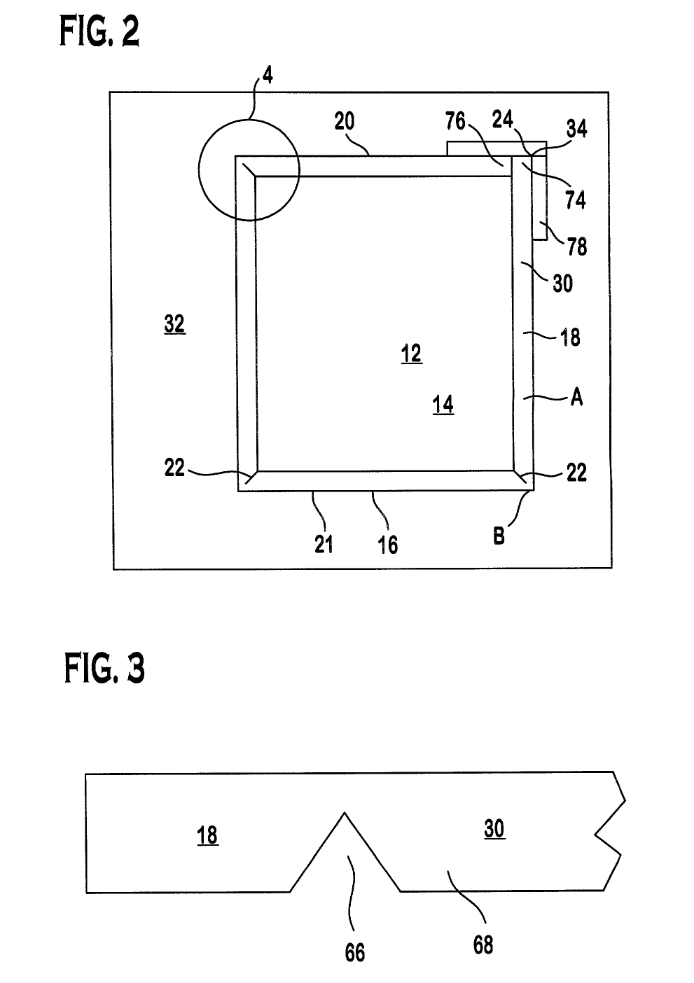

Referring to FIG. 6, it is preferred that the tape 18 of the present invention have a foam core 26 with an adhesive 28 disposed on both sides. A releaseable liner 18 is preferably disposed over the adhesive 28 on one side of the foam core 26. The width of the tape as viewed in FIG. 2 is preferably about three-eighths of an inch. The particular properties, adhesive 28, core 26 and dimensions of tape 18 used with the tape applicator 10 can be varied depending upon the particular application as understood from this disclosure by those of ordinary skill in the art.

Preferably, a plurality of rollers 52 retain the tape 18 positioned in the feed path 38 and prevent the brake 56, the first cutting member 58 and the second cutting member 60 from moving the tape 18 out of alignment with the tape feed path 38. The number and placement of rollers can be varied without departing from the scope of the present invention. Preferably the rollers have stick resistant surfaces which engage a sticky side of double-sided tape with a covered side of double-sided tape maintained against the tape guide 40 by the rollers 52.

The method of the present invention using the tape applicator 10 to dispense tape on a major surface 12 of a panel 14 is described below with reference to the Figures. The tape 18 is preferably applied along a panel surface 12 even with the edges 20 of the panel 14 as shown in FIG. 2. However, in some instances, it is desirable to apply the tape on the surface 12 inset from the edges 20 a predetermined distance. This is easily controlled by adjusting the initial application location of the applicator head 10 and the applicator head turning as described below.

Referring to FIG. 2, the method of applying tape includes positioning a panel 14 on the panel support 32 with the tape applicator raised such that a first panel corner 24 is positioned at the predetermined reference point 34. To facilitate aligning the panel 14 with the predetermined reference point a panel guide 78 may be used. For rectangular panels, the panel guide 78 is configured with an interior angle of 90°. By snugly fitting the panel 14 against the panel guide 78, a first panel corner is precisely aligned for the tape application process. The tape applicator 10, having a free end of tape 18 disposed proximate the pressing roller 46 is positioned above the aligned panel 14 based upon the predetermined reference point and any tape application inset distance from the panel edge. Once positioned, the tape is aligned for application in the “Y” direction, as referenced in FIG. 1, even with a first panel edge or a selected inset distance from a first panel edge.

Once the panel is aligned, automatic sequencing is initiated by the operator. The applicator 10 is lowered to adhere the free tape end proximate the pressing roller 46 to the surface 12 of the panel 14 proximate the aligned first panel corner. The tape applicator 10 is then moved above the panel 14 in the “Y” and “X” directions along a path proximate the panel perimeter so that tape corners 22 are formed on the surface 12 that correspond to the panel corners 24. In the preferred embodiment a single piece of tape 18 is adhered on the surface 12 of the panel 14 proximate to and substantially along the perimeter 16 of the panel 14.

As the tape applicator is moved in a straight line in the “Y” then “X” direction while applying tape 18, the sensor 54 senses the approach of the tape applicator 10 relative to successive panel corner to indicate the need to form a tape corner. Preferably, the sensor is configured to sense the presence or absence of the surface of a panel disposed directly beneath it. A conventional proximity sensor is preferred. Accordingly, the panel surface presence is sensed while the tape is applied in the “Y” or “X” direction until the sensor passed over a panel edge at which point the sensor 54 sends a signal to the controller 50.

During tape application, when the sensor 54 senses the absence of the panel surface, the sensor 54 sends a signal to the controller 50, thereby signaling the approach of a panel corner. The controller 50 selectively engages either the first or second cutting member 58, 60 to partially sever or notch the tape 18. The controller controls the cutting action based upon parameters including the predetermined distance between the sensor 54 and the pressing roller 46, the distance between the pressing roller and the respective cutting member 58, 60, and the inset distance, if any, from a panel edge for tape application. For rectangular panels, sensing is only required for the first two corners that are approached due to panel symmetry.

In lieu of the controller 50 performing a mathematical calculation to determine when the controller 50 is to activate the first or second cutting members, the sensor 54 and/or the cutting members 58, 60 may be adjustably mounted on the applicator head and secured at specific distance from the pressing roller 46 so that upon sensing of a panel edge by the sensor 54, the respective cutting member is immediately activated to cut the tape at the desired location. However, it is preferred to utilize the computational capability of the computer controller to reduce the amount of sensing required.

In forming the first three tape corners on a rectangular panel, the controller also uses the above-referenced parameters to control the “Z” axis rotation of the tape applicator 10, to rotate the applicator 90° when a notched portion of the tape is applied. For example, referring to FIG. 2, if the tape applicator 10 is applying tape to the panel 14 at position “A” and is moving generally in the “Y” direction (as referenced in FIG. 1) toward the panel corner 24 identified as “B,” the tape applicator sensor 54 determines the position of the tape applicator 10 relative to the lower edge 21 of the panel 14 to determine when the tape applicator 10 will form a tape corner corresponding to the panel corner 24 labeled “B”.

Referring to FIG. 3, a notch 66 is cut into tape 18 in response to the approach of each of the panel corners 24, except for the first panel corner 24 located at the predetermined reference point 34. The notch 66 is cut in the tape 18 to form a tape corner 22 such that the tape corner 22 is relatively flat. As shown in FIG. 4, the inclusion of a notch in the portion of the tape which forms the tape corners 22 reduces the amount of bunched tape 70 located at the tape corners 22 and results in the corresponding tape corner being relatively flat.

Referring to FIGS. 3 and 4, the tape punch 64 is configured to punch a generally triangular shaped notch 66 in the tape 18. However, other notch shapes can be used without departing from the scope of the present invention. Depending on the angle through which the tape 18 is bent proximate to the panel corner 24, the shape and size of the notch 66 that best reduces the amount of bunched tape 70 at a tape corner 22 may vary.

When the tape applicator head 10 approaches the return to the first panel corner, instead of notching the tape, the controller 50 effects an ending sequence to form a final corner corresponding to the first panel corner. Referring to FIGS. 1, 2 and 5, the ending sequence includes partially severing the tape 18 to form a partially cut section 72. The severing is preferably made at location calculated to abut the severed end to the initially applied free end to thereby result in the formation of a flat tape corner. To determine the precise location of severing, the controller 50 uses an additional parameter, namely, the tape width. For example when the tape applicator 10 is dispensing tape 18 along the last edge 20 of the panel 14 (the upper edge of the panel 14 of FIG. 2), the tape applicator 10 partially severs the tape at a location corresponding to the completion of the tape pattern to avoid overlapping the initially applied tape 18.

Once the partial severing is performed, the controller continues movement of the tape applicator head 10 in the “X” axis direction over the initially applied free end of the tape 18. As the tape applicator 10 approaches the initially applied tape, the controller 50 also raises the tape applicator 10 and applies the tape brake 56. The raising of the applicator head 10 disengages the pressing roller 46. The brake application causes the tape 18 to be separated from the tape applicator 10 at the severed section 72 by preventing the feeding of tape 18 while still moving the tape applicator 10.

The desired tape pattern is thus completed on the panel 14 with the partially cut section 72 forming the last end 76 of the tape 18 generally flushly align with a longitudinal edge of the initial end 74 of the tape 18 that was applied to the panel 14. Since the tape head is preferably raised before crossing over the initially applied tape, the separated end may not be fully adhered to the panel. In such case, the operator can simply press on the separated end to complete the corner. However, substantial abutment of the severed end is assured by the control of the cutting mechanism.

Additionally, the brake is preferably selectively applied by the controller 50, based on the distance between the severing cutter 60 and the pressure roller 46 along the tape path 38 such that after severing a free tape end remains proximate the pressure roller 46. Preferably, the ending sequence for tape application to rectangular panels is completed by the controller 50 controlling a 270° counter rotation of the tape applicator 10 and the release of the tape brake 54.

It is recognized by those skilled in the art, that changes may be made to the above-described embodiments of the invention without departing from the broad inventive concept thereof. For example, the shape of the panel 14 and the support 32 can be triangular, hexagonal or irregularly shaped without departing from the scope of the present invention. In such cases, the rotation of the tape application would be varied accordingly along with the shape of the panel guide 78. Additionally, the preferred shape of the notch 66 or the position of the various components of the tape applicator 10 along the tape feed path 38 can be changed without departing from the scope of the present invention. While separate cutters are preferred, a single cutting mechanism can be provided to perform both the notching and severing function. For example, the notch may be cut in a manner which also adequately serves as the partial severed portion 72 referenced above so that the notching mechanism 60 serves both to notch and partially sever the tape. It is understood, therefore, that this invention is not limited to the particular embodiment disclosed, but is intended to cover all modifications which are within the spirit and scope of the invention as defined by the appended claims.

I claim:

1. An apparatus for applying a tape to a surface of a panel having a perimeter including a plurality of edges that form a plurality of successive panel corners, comprising:
a panel support configured to receive a panel with a first corner of the panel selectively position with respect to a predetermined reference point;
a tape applicator and an associated controller;
the tape applicator selectively movable in response to the controller over a panel positioned on the panel support along a path generally corresponding to the perimeter of the panel so that a plurality of tape corners are formed on the surface that correspond to the plurality of successive panel corners;
the tape applicator comprising:
a sensing mechanism associated with the controller which selectively determines the position of the tape applicator relative to a panel as the applicator approaches at least one of the successive panel corners;
a tape feed path having an inlet for receiving tape from a tape supply and an outlet where at tape is dispensed for application to a panel;
a pressing member proximate said feed path outlet configured to press the tape onto the surface of a panel while the tape applicator moves above the panel;
a cutting member selectively positioned along the tape feed path and controlled by the controller to partially cut tape disposed in the feed path; and
a tape brake positioned along the tape feed path and controlled by the controller to prevent movement of tape disposed in the tape feed path.

2. The apparatus according to claim 1 wherein the tape applicator includes first and second cutting members operatively associated with the controller, the first cutting member selectively positioned along the tape feed path to cut a notch along a longitudinal edge of tape disposed within the feed path at a selected position controlled by the controller, and the second cutting member selectively positioned along the tape feed path to substantially sever tape disposed within the feed path at a selected position controlled by the controller.

3. The apparatus according to claim 2 wherein the sensing mechanism is positioned a selected distance in advance of the pressing member to detect the presence or absence of a panel disposed beneath the sensing mechanism whereby, as the tape applicator applies tape to a panel from a first panel corner to a second panel corner, the sensing mechanism senses the presence of the tape panel when the tape applicator is remote from the second panel corner and the sensing mechanism, upon crossing a panel edge, senses the absence of the panel indicating the approach of the tape applicator to the second panel corner.

4. An apparatus according to claim 2 selectively configured for applying tape to a surface of a rectangular panel having a perimeter including four edges that form four successive 90° panel corners wherein:
the controller controls the movement of the tape applicator to initially move forward in a first direction away from a first corner of a rectangular panel aligned with the predetermined reference point;
the controller receiving first and second successive signals from the sensing mechanism indicating the approach of the tape applicator to second and third successive panel corners and calculating the approach of a fourth and the first panel corners based upon the previously received signals;
as each of the second, third and fourth panel corners are approached, the controller selectively controls the first cutting member to cut a notch in tape disposed in the tape feed path thereby forming a notched portion, continues to move the tape applicator in the same direction until the notch portion contacts the surface of the rectangular panel, and then activates a 90° turn of the tape applicator whereafter forward movement of the tape applicator continues toward a next successive panel corner; and
as the return to the first panel corner is approached, the controller selectively controls the second cutting member to substantially sever tape disposed in the feed path, continues the same forward direction of travel of the tape applicator across tape initially applied proximate the first panel corner and selectively activates the tape brake as the tape applicator continues to move past the initially applied tape causing the tape to break at the point where the tape was substantially severed.

5. The apparatus according to claim 4 wherein the sensing mechanism is positioned a selected distance in advance of the pressing member to detect the presence or absence of a panel disposed beneath the sensing mechanism whereby, as the tape applicator applies tape to a panel, the sensing mechanism senses the presence of the tape panel when the tape applicator is remote from said second or third successive panel corner and the sensing mechanism, upon crossing a panel edge, senses the absence of the panel indicating the approach of the tape applicator to said second or third successive panel corners.

6. The apparatus according to claim 4 wherein the first cutting member is a tape punch configured to punch a generally triangular shaped notch in tape disposed in the tape feed path.

7. The apparatus according to claim 4 wherein the tape feed path is configured to receive a double-sided tape having a protective covering on one side wherein the tape feed path includes a tape guide for receiving the covered side of the tape and a plurality of stick resistant rollers disposed in front of the tape guide for contact with the non-covered side of the tape such that the rollers maintain the tape against the tape guide as tape travels through the tape feed path.

8. The apparatus according to claim 4 wherein the controller activates a 270° counter rotation of the tape applicator and the release of the tape brake following the complete severing of the tape.

9. The apparatus according to claim 1 wherein the tape feed path is configured to receive a double-sided tape having a protective covering on one side wherein the tape feed path includes a tape guide for receiving the covered side of the tape and a plurality of stick resistant rollers disposed in front of the tape guide for contact with the non-covered side of the tape such that the rollers maintain the tape against the tape guide as tape travels through the tape feed path.

10. An apparatus according to claim 1 wherein the pressing member is a roller.

11. A method of applying a tape to a surface of a panel having a perimeter including a plurality of edges that form a plurality of successive panel corners, comprising:
providing a panel support for aligning a first corner panel with a predetermined reference point on the panel support;
providing a tape applicator selectively movable over a panel positioned on the panel support, the tape applicator having a sensing mechanism for selectively determining the position of the tape applicator relative to the panel;
positioning a panel on the panel support such that a first corner is positioned at the predetermined reference point thereby presenting a panel surface for tape application;
dispensing tape from the tape applicator and applying the tape to the surface of the panel starting proximate the first panel corner and moving the tape applicator along a path proximate each successive corner generally corresponding to the perimeter of the panel so that a plurality of tape corners are formed on the surface that correspond to the plurality of successive panel corners;
sensing the position of the tape applicator relative to the approach of at least one successive corner along the path;
in response to approaching each successive corner, selectively partially cutting the tape such that:
a notched portion of the tape formed as the tape applicator approaches each panel corner, except the first corner, which notched portion is used to form a corresponding tape corner which is relatively flat; and
a partially severed tape section is formed as the tape applicator approaches the first corner which partially severed portion is used to form a relatively flat tape corner corresponding to said first panel corner; and
subsequent to the tape applicator approaching the first corner, preventing the feeding of additional tape from the tape applicator while continuing to move the tape applicator causing the tape to separate from the tape applicator at the partially cut section whereby a single piece of the tape is adhered to the surface of the panel in a pattern corresponding generally to the perimeter of the panel.

12. The method of claim 11 wherein the step of positioning the panel comprises positioning a panel having a rectangular shape and the tape applicator forms four successive tape corners by being rotated 90° during the formation of each of the first three tape corners as they are formed.

13. The method of claim 12 wherein the tape application is counter-rotated 270° after the formation of the fourth tape corner to facilitate the application of tape to another panel.

14. The method of claim 11 of applying a tape to a surface of a rectangular panel having a parameter including four edges that form four successive panel corners wherein
a rectangular panel is positioned on the panel support;
in response to the tape applicator approaching each of a second, third, or fourth successive panel corner, the tape being dispensed is notched and the dispensing tape applicator is rotated 90° when the notched portion is applied to the panel thereby forming a corresponding taped corner; and
following the separation of the tape from the tape applicator in conjunction with the formation of a tape corner proximate the first corner, the tape applicator is counter-rotated 270° and the preventing of the feeding of additional tape from the tape applicator is ceased.

15. The method according to claim 14 wherein the sensing the position of the tape applicator includes sensing of the presence of a panel in advance of the application of tape by the tape applicator while it is remote from the second or the third successive panel corners and sensing the absence of a panel in advance of the application of the tape by the tape applicator to indicate the approach of the tape applicator to the second or the third successive corner along the path of tape application.

16. The method according to claim 11 wherein the sensing the position of the tape applicator includes sensing of the presence of a panel in advance of the application of tape by the tape applicator while it is remote from a second successive panel corner and sensing the absence of a panel in advance of the application of the tape by the tape applicator to indicate the approach of the tape applicator to the second successive corner along the path of tape application.

17. The method of claim 11 wherein:
the step of providing a tape applicator comprises providing a tape applicator having a tape dispensing brake disposed on an applicator body proximate to a tape feed path, the tape dispensing brake being configured to move between a first position, in which the tape dispensing brake contacts the tape and prevents movement of the tape along the tape feed path, and a second position, in which the tape dispensing brake is disengaged from the tape; and
the step of preventing the feeding of additional tape comprises moving the tape dispensing brake into the first position to prevent the movement of the tape along the tape feed path.

18. The method of claim 11 wherein the step of providing a tape applicator comprises providing a tape applicator having a first cutting member disposed on an applicator body proximate to a tape feed path and having a cutting edge, the cutting edge being movable into contact with the tape to slice partially through a portion of the tape.

19. The method of claim 13 wherein the step of providing a tape applicator comprises providing a tape applicator having a second cutting member disposed on the applicator body proximate to the tape feed path and having a tape punch, the tape punch being contactible with the tape to cut a notch along a longitudinal edge of the tape.
